(19) United States
(12) Patent Application Publication
(10) Pub. No.: US 2005/0104344 A1
(43) Pub. Date: May 19, 2005

(54) Structure of vehicle head lining

(76) Inventor: Gyu-Jong Kim, Hwaseong-city (KR)

Correspondence Address: MORGAN, LEWIS & BOCKIUS LLP (SF), 2 PALO ALTO SQUARE, PALO ALTO, CA, 94306, US

(21) Appl. No.: 10/963,846

(22) Filed: Oct. 13, 2004

(30) Foreign Application Priority Data
Nov. 13, 2003 (KR) 10-2003-0080135

(51) Int. Cl. B60R 21/22

(52) U.S. Cl. 280/730.2

(57) ABSTRACT

A vehicle head lining is adapted to properly deform or fracture during deployment of a curtain airbag. The head lining structure prevents nearby components of the curtain airbag from being damaged and provides a stable and effective operation of the curtain airbag.

### CROSS-REFERENCE TO RELATED APPLICATIONS

This application claims priority of Korean Application No. 10-2003-0080135, filed on Nov. 13, 2003, the disclosure of which is incorporated fully herein by reference.

### TECHNICAL FIELD OF THE INVENTION

Generally, the present invention relates to a head lining structure of a vehicle. More particularly, the structure relates to a curtain airbag installation part.

### BACKGROUND OF THE INVENTION

Typically, the ceiling of a passenger compartment of a vehicle is finished with a head lining. A curtain airbag is installed along an upper lateral side of the vehicle passenger compartment and is prevented from being exposed into the compartment, prior to deployment, by the head lining.

When the curtain airbag is deployed or inflates into the passenger compartment, the head lining is deformed or fractured. A drawback of the existing passenger compartment structure is that the head lining is not properly deformed or fractured during deployment of the airbag. Therefore, nearby components are damaged and can even obstruct the curtain airbag from inflating according to its designed intent.

### SUMMARY OF THE INVENTION

According to an embodiment, the present invention prevents damage of components nearby a curtain airbag by placing a head lining to properly be deformed or fractured during inflation of the curtain airbag. Thereby, enabling the airbag to deploy properly.

In a preferred embodiment of the present invention, the structure of a vehicle head lining includes a head lining whose one end is secured between a roof side inner rail and a central pillar trim. A vulnerable portion is formed on the head lining where the curtain airbag intersects with the head lining during deployment of the curtain airbag.

### BRIEF DESCRIPTION OF THE DRAWINGS

For a better understanding of the nature and objects of the present invention, reference should be made to the following detailed description with the accompanying drawings, in which:

FIG. 1 is a transverse cross section of an upper right corner of a vehicle passenger compartment illustrating a structure of a vehicle head lining according to an embodiment of the present invention; and

FIG. 2 represents the operation of the head lining when the curtain airbag of FIG. 1 inflates.

### DETAILED DESCRIPTION OF PREFERRED EMBODIMENTS

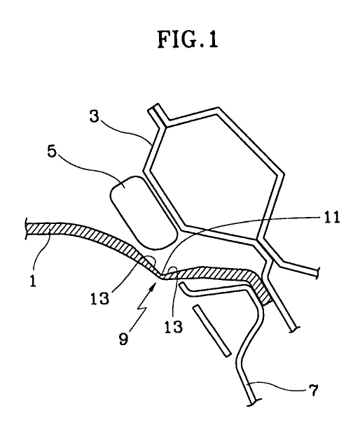

According to FIG. 1, a curtain airbag 5 is mounted at a space between a head lining 1 and a roof side inner rail 3. One end of the head lining 1 is fixed between the roof side inner rail 3 and a central pillar trim 7. A vulnerable portion 9 is formed on the head lining 1 at a location where the curtain airbag 5 intersects with the head lining 1 during the deployment of the curtain airbag 5.

According to an exemplary embodiment, the vulnerable portion 9 is constituted by a groove 11 facing the curtain airbag 5 of the head lining 1. Two inclined sides 13 converge at the groove 11 to form a slight depression at the surface of the head lining 1. Accordingly, the head lining 1 is thinnest where the two inclined sides 13 converge, at the groove 11. The head lining 1 is designed to be easily fractured at this convergence during the deployment of the curtain airbag 5.

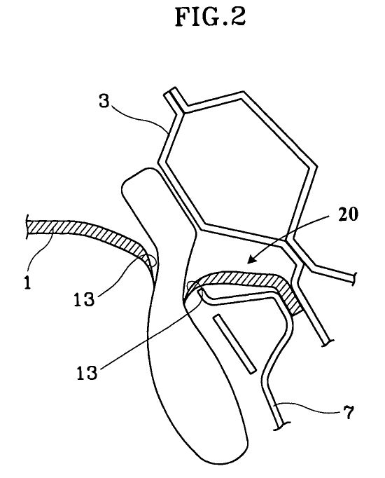

When the head lining 1 is firmly fixed at one end to the vehicle body, as described, and the curtain airbag 5 inflates as shown in FIG. 2, the vulnerable portion 9 of the head lining 1 is fractured and deformed as illustrated. The groove 11, formed at the head lining 1 and intersecting the curtain airbag 5 along the inflation direction of the curtain airbag 5, is torn via the inflation pressure of the curtain airbag 5. Since the groove 11 is composed of the two inclined sides 13, when the curtain airbag 5 inflates, the groove 11 rips and the inclined sides 13 stably guide the curtain airbag 5 at both ends along the deployment direction of the curtain airbag 5. Thereby a channel is formed through which the curtain airbag 5 passes and expands into the passage compartment.

As the curtain airbag 5 inflates into the passenger compartment through the torn portion of the head lining 1, the curtain airbag 5 avoids hitting the neighboring central pillar trim 7 and the like. To accomplish this, the groove 11 is positioned such that upon inflation of the airbag 5, a flap 20 of the head lining 1 is sufficiently sized to cover the central pillar trim 7. Accordingly, this configuration prevents the central pillar trim 7 from being damaged or destroyed and the curtain airbag 5 from being jammed or torn by the central pillar trim 7 or the like. Furthermore, in the head lining structure thus constructed, the inflation speed and inflation direction of the curtain airbag 5 may precisely be directed and restricted according to the shape of the groove 11, thus improving the operating efficiency of the curtain airbag 5.

As apparent from the foregoing, the head lining is adapted to be properly deformed or fractured during deployment of the curtain airbag. Thereby, preventing nearby components of the curtain airbag from being damaged and obtaining a stable and effective operation of the curtain airbag.

1. A structure of a vehicle head lining, the structure comprising:
a head lining with one end secured between a roof side inner rail and a central pillar trim; and
a vulnerable portion formed on said head lining where a curtain airbag intersects with said head lining during deployment of said curtain airbag.

2. The structure as defined in claim 1, wherein said vulnerable portion is constituted by a groove in said head lining facing said curtain airbag.

3. The structure as defined in claim 2, wherein two inclined sides of said head lining converge at said groove to form a slight depression at an inner surface of said head lining.

4. The structure as defined in claim 1, wherein said vulnerable portion is positioned with respect to the central pillar trim such that, upon deployment of the curtain airbag, a flap of the head lining is formed that covers the central pillar trim.

5. The structure as defined in claim 4, wherein the flap insulates the curtain airbag from damage by the central pillar trim and insulates the central pillar trim from damage by the curtain airbag.

6. The structure as defined in claim 1, wherein said vulnerable portion is configured and dimensioned to guide deployment of said curtain airbag in a preferred deployment direction.

7. A structure of a vehicle head lining, the structure comprising:
a head lining with one end secured between a roof side inner rail and a central pillar trim; and
a vulnerable portion formed on said head lining where a curtain airbag intersects with said head lining during deployment of said curtain airbag, wherein said vulnerable portion is positioned with respect to the central pillar trim such that, upon deployment of the curtain airbag, a flap of the head lining covers the central pillar trim, thereby limiting contact between the curtain airbag and the central pillar trim.
